(19) United States
(12) Patent Application Publication
(10) Pub. No.: US 2014/0001741 A1
(43) Pub. Date: Jan. 2, 2014

(54) DOCUMENT BINDER

(71) Applicant: FARN WANG, TAIPEI CITY (TW)

(72) Inventor: FARN WANG, TAIPEI CITY (TW)

(21) Appl. No.: 13/762,582

(22) Filed: Feb. 8, 2013

(30) Foreign Application Priority Data
Jun. 27, 2012 (TW) 101122972

(51) Int. Cl. B42D 3/04

(52) U.S. Cl. CPC B42D 3/045
USPC 281/45

(57) ABSTRACT

A document binder for bonding one or more books includes a cover, a holding base, a first holding member, a second holding member and at least one rod. The cover has a front cover, a back cover and a back board disposed between the front and back covers. The back board has a base plate pivotally connecting the front and back covers. The holding base is secured on the base plate and immobile. The first and second holding members are secured on the opposite end of the holding base and projecting there-from. The rods go through the spine portion of the books and the two ends thereof are arranged in the holding members.

### BACKGROUND

1. Field of the Invention

The instant disclosure relates to a document binder; in particular, to a document binder bonding with at least one book.

2. Description of Related Art

A loose leaf binder is a document binder specializing in binding punched paper or fillings. A conventional loose leaf binder has a binder located at the central region inside. The binder has a plurality of rings or studs. When the rings are pushed apart to an open state, each ring resembles “C” which allows the punched paper for going through from the end. When the rings are pulled back together to a closed state, each ring resembles “O” and the paper is retained thereby.

The aforementioned loose leaf binder can only retain loose leaf paper. For a spiral (coil) bound notebook, wires go through all apertures on the paper so the paper has no more room for the ring binder. That is to say, the spiral bound notebook cannot fit into the conventional loose leaf binder. When the cover of the spiral bound notebook is stained, a new cover cannot replace the damaged cover. Furthermore, when the cover falls off the spiral bound notebook, the fillings do not have cover protection anymore and are prone to potential damage.

### SUMMARY OF THE INVENTION

The instant disclosure is to provide a document binder bonding with at least one book for protection.

The book includes a spine portion and the document binder includes a cover, a holding base, a first holding member, a second holding member and at least one rod. The cover has a front cover, a back cover and a back board connecting the front and back covers. The back board has a base plate which pivotally connects the front and back covers to allow the front and back covers for pivoting toward the base plate. The holding base is secured on the base plate and immobile as the back board moves. The holding base has an upper face and an opposed lower face. The lower face is disposed between the upper face and the base plate. The first and second holding members are fixed on the opposite side of the holding base and projecting from the upper face. The rods go through the spine portion of the book and are secured by the first and second holding members from two ends thereof.

In summary, the rods can go through the spine portion of the book and being secured on two ends by the first and second holding members. Thus the exemplary embodiment of the instant disclosure bonds with spiral bound notebook and provides protection.

In order to further understand the instant disclosure, the following embodiments are provided along with illustrations to facilitate the appreciation of the instant disclosure; however, the appended drawings are merely provided for reference and illustration, without any intention to be used for limiting the scope of the instant disclosure.

### BRIEF DESCRIPTION OF THE DRAWINGS

FIG. 1A is a perspective view of a document binder in accordance with an embodiment of the instant disclosure.

FIG. 1B is an exploded view of the document binder shown in FIG. 1A.

FIG. 2A is a perspective view of a document binder in accordance with another embodiment of the instant disclosure.

FIG. 2B is an enlarged view of a first holding member of the document binder shown in FIG. 2A.

FIG. 3 is a perspective view of a document binder in accordance with another embodiment of the instant disclosure.

FIG. 4 is a perspective view of a document binder in accordance with another embodiment of the instant disclosure.

FIG. 5 is a perspective view of document binder in accordance with another embodiment of the instant disclosure.

FIG. 6 is a perspective view of document binder in accordance with another embodiment of the instant disclosure.

### DETAILED DESCRIPTION OF THE PREFERRED EMBODIMENTS

The aforementioned illustrations and following detailed descriptions are exemplary for the purpose of further explaining the scope of the instant disclosure. Other objectives and advantages related to the instant disclosure will be illustrated in the subsequent descriptions and appended drawings.

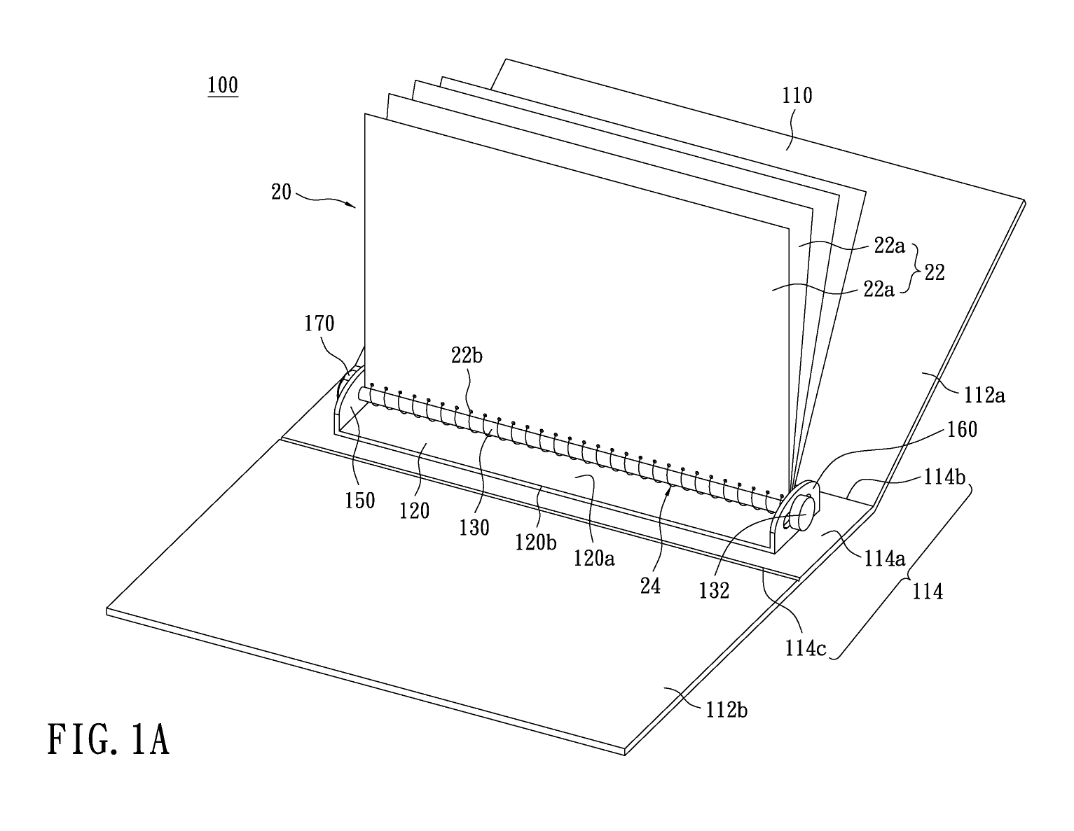

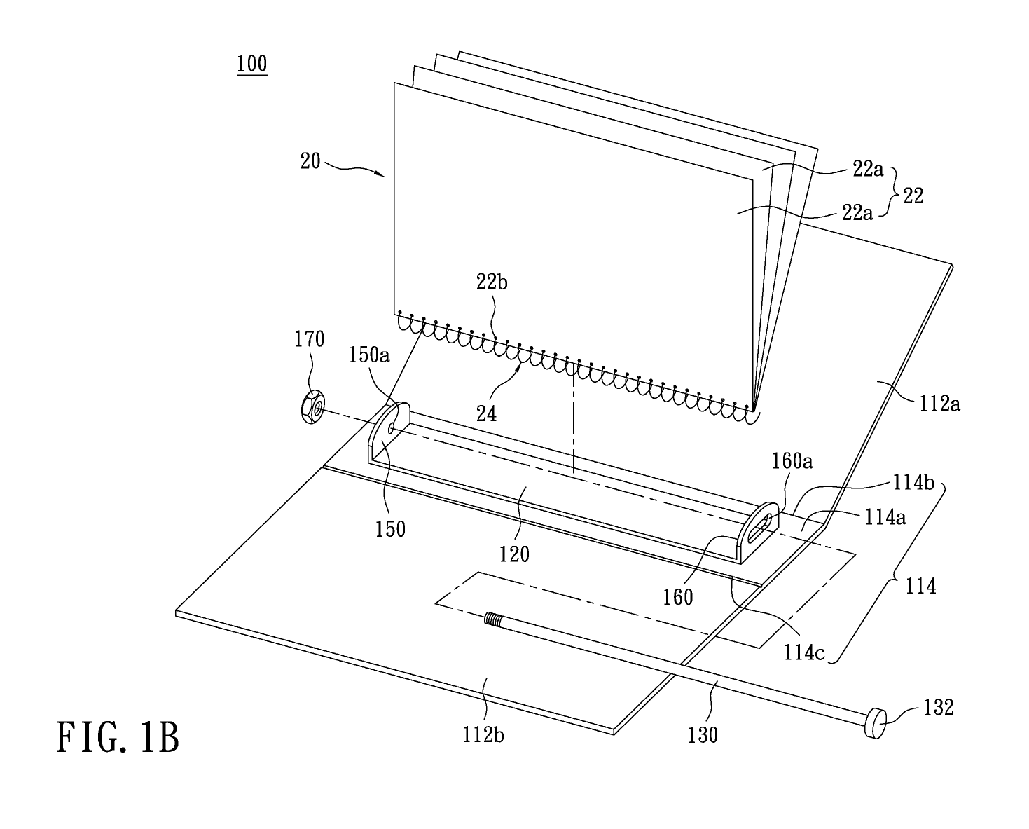

FIG. 1A shows a perspective view of a document binder 100 in accordance with an embodiment of the instant disclosure. Please refer to FIG. 1A. The document binder 100 includes a cover 110, a holding base 120, a first holding member 150, a second holding member 160 and a rod 130. The cover 110 has a front cover 112a, a back cover 112b and a back board 114. The back board 114 has a base plate 114a which has a pair of opposing linear edges 114b, 114c. The linear edge 114b connects the front cover 112a while the linear edge 114c connects the back cover 112b. However, in another embodiment, the cover 110 can be made of soft materials which may not distinctively show the linear edges 114b, 114c to naked eyes.

In addition, back board 114 pivotally connects the front cover 112a and back cover 112b. Specifically, the front cover 112a can rotate along the back board 114 using linear edge 114b as a shaft. Similarly, the front cover 112a can rotate along the back board 114 using linear edge 114c as a shaft. Therefore the front cover 112a and back cover 112b can rotate toward the base plate 114a by using linear edges 114b, 114c respectively.

The holding base 120 has a lower face 120b and an upper face 120a opposing the lower face 120b. The lower face 120b is disposed between the upper face 120a and the base plate 114a. The holding base 120 is firmly secured on the base plate 114a of the back board 114. For example, the holding base 120 is secured by adhesive, bolts or nails (not shown) and permanently bonded to the back board 114. Hence, unless intentionally breaking the bond, the holding base 120 does not shift as the back board 114 moves and not detach there-from either.

The first holding member 150 and the second holding member 160 are fixed on the opposite side of the holding base 120 and stretch out from the upper face 120a. The rod 130 is arranged between the holding members 150, 160. More specifically, the two ends of the rod 130 are engaged with the first holding member 150 and the second holding member 160 respectively. The rod 130 extends along one of the linear edges 114b or 114c and locates within the linear edges.

FIG. 1B is an exploded view of the document binder 100 in FIG. 1A. Please refer to FIGS. 1A and 1B. The first holding member 150 has at least one first rod hole and the second holding member 160 has at least one second rod hole 160a. The rod holes 150a, 160a can be elongated shaped to allow insertion for the plurality of rods 130.

The document binder 100 further includes at least one cap 170. One end of the rod 130 has an arresting portion 132 and the other end can engage with the cap 170. For example, screws or other fastening methods are used to engage the rod 130 and cap 170. The rod 130 goes through the first and second rod holes 150a, 160a. The cap 170 secures the rod 130 from one end and abuts the first holding member 150 while the arresting portion 132 abuts the second holding member 160. The second holding member 160 is located between the arresting portion 132 and first holding member 150. The first and second holding members 150, 160 are located between the cap 170 and arresting portion 132. Thus the rod 130 will not slide off from the first or second holding members 150, 160.

The document binder 100 is used to bond with a book 20. The book 20 can be such as a spiral bond notebook including a loose leaf book 22 and a spine portion 24. The loose leaf book 22 has a plurality of fillings 22a each of which has a plurality of apertures 22b. The spine portion 24 may have wires going through the apertures 22b to form a plurality of coils. For example, the spine portion 24 can form spiral bound binding. However, the book can be bound by pegs as well and the binding method is not limited to the instant embodiment.

The rod 130 goes through the spine portion 24. When the rod 130 goes through the spine portion 24 and inserts into the rod holes 150a, 160a. The rod 130 will be fixed between the first holding member 150 and the second holding member 160 of the holding base 120. The document binder 100 is then bonded with the book 20. Hence the document binder 100 can be the cover which protects the book 20 and prevents from fillings 22a being stained or damaged.

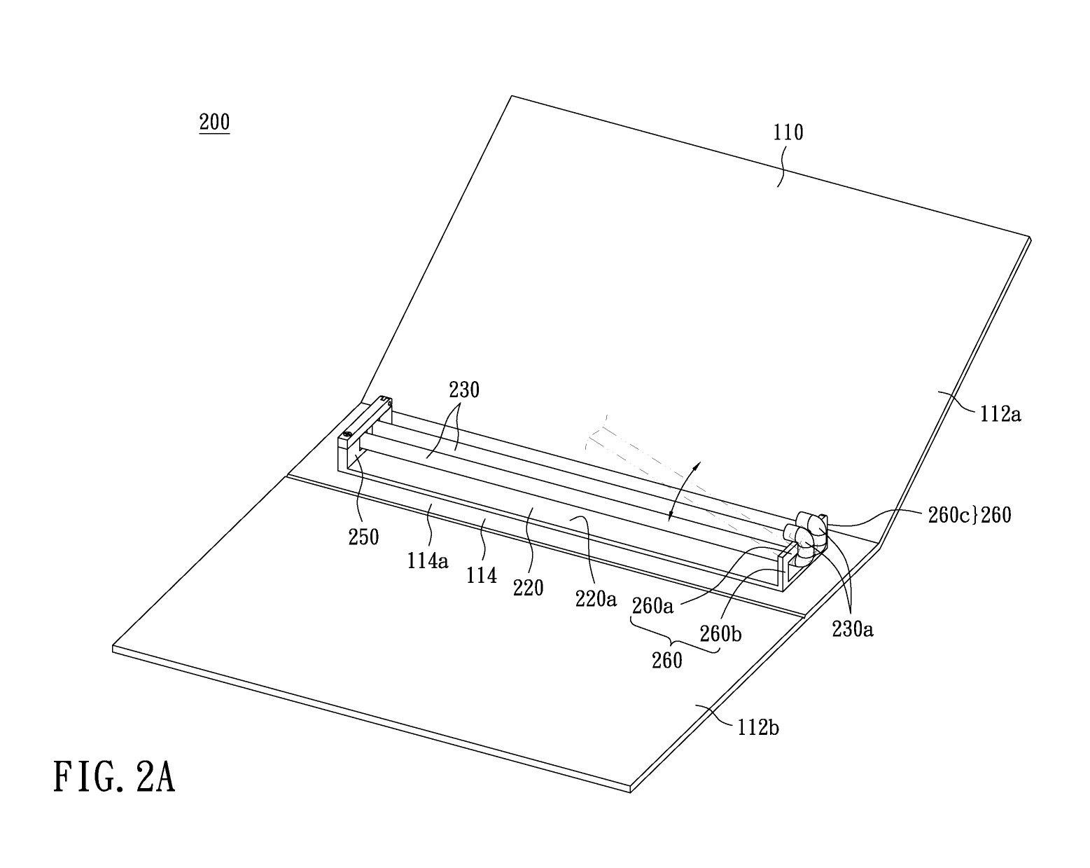

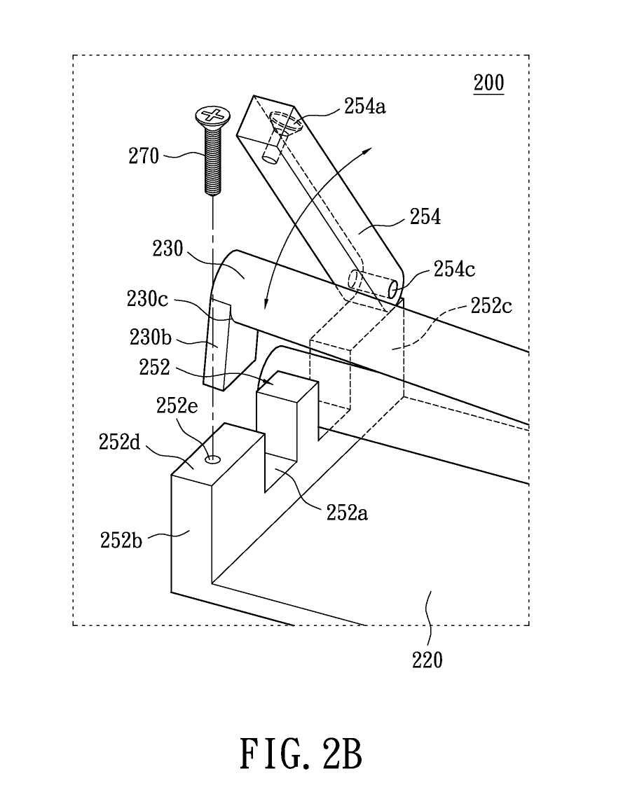

FIG. 2A is a perspective view of a document binder 200 in accordance with another embodiment of the instant disclosure. FIG. 2B is an enlarged view of a first holding member in FIG. 2A. Please refer to FIGS. 2A and 2B. The instant embodiment is formed in a similar manner to that of the aforementioned embodiment, document binder 100. For example, the document 200 includes a cover 110, a holding base 220, a first holding member 250 and a second holding member 260. The first and second holding member 250, 260 are disposed on the opposite side of the holding base 220 respectively. The holding base 220 is firmly secured on the base plate 114a of the back board 114.

However, the instant embodiment and the aforementioned embodiment have difference there-between. Specifically, in the instant embodiment, the document binder 200 further includes two rods 230, and each end of the rods 230 are disposed on the holding members 250, 260 respectively. Hence, the rods 230 can go through the wires 24 of two books 20 respectively allowing bonding among the document binder 200 and the two books 20 (referring to FIG. 1A). In addition, the rods 230 are arranged in parallel and the distance between each of the rods 230 and the upper face 220a is substantially identical.

Furthermore, in another embodiment, one end of the rod 230 can be firmly secured on the second holding member 260 and being atop on the holding base 220. The rod 230 may be a resilient plastic stick or a solid stick.

Moreover, the first holding member 250 has a seat 252, a pivoting arm 254 and a screw 270. The seat 252 has a bottom 252a, a first column 252b and a second column 252c. The first and second columns 252b, 252c projects from the bottom 252a and the bottom 252a connects to the holding base 220. The first column 252b has a top end 252d formed with a screw hole 252e for receiving a screw 270. Additionally, as shown in FIG. 2B, between the first column 252b and the second column 252c, another column is present. In another embodiment, the additional column is optional.

The pivoting arm 254 is disposed on top of the pair of columns 252b, 252c and the pivoting arm 254 pivotally connects the second column 252c. For example, the pivoting arm 254 can rotate along a rotation centre 254c and close toward the second column 252c. The axis of the rotation centre 254c may align with the rods 230. In other words, the axis of the rotation centre 254c can be parallel to the rods 230. Moreover, the pivoting arm 254 is formed with a screw hole 254a corresponding to the through hole 254a. The rotation of the pivoting arm 254 toward the second column 252c allows the through hole 254a for alignment with the screw hole 252e. The screw 270 can then go through the pivoting arm 254 and match the screw hole 252e. Therefore, one end of the rod 230 can be retained between the pivoting arm 254 and holding base 220.

In addition, the rods 230 may be L-shaped rods having a bent portion 230c and an extension 230b that connects to the bent portion 230c (as shown in FIG. 2B). The combined length of the bent portion 230c and extension 230b of the rod 230 has to be shorter than the ring diameter. For example, the spine portion 24 may be spiral bound ring and the combined length of the bent portion 230c and extension 230b cannot exceed the inner diameter created by the coil. Alternatively, the book 20 may have a plurality of pegs and the length of the bent portion 230c and extension 230b has to be shorter than the peg diameter. Hence, the rod 230 can go through the spine portion 24 smoothly to bond the document binder 200 and book 20 (as shown in FIG. 1B).

When the bent portion 230c is disposed between the pivoting arm 254 and base plate 114a, the extension 230b stretches from the bent portion 230c toward the base plate 114a. Additionally, the one end of the rod 230 may be a hook portion 230a (as shown in FIG. 2A) and the hook portion 230a engages with the second holding member 260.

Specifically, the second holding member 260 has a supporting pole 260a, a third column 260b and a fourth column 260c. The third and fourth columns 260b, 260c projects from the holding base 220. The supporting pole 260a engages with the hook portion 230a. For example, the hook portion 230a engages with the supporting pole 260a and is sandwiched between the third and fourth columns 260b, 260c. The third and fourth columns 260b, 260c are arranged between the supporting pole 260a and holding base 220.

Furthermore, the rod 230 can pivotally connect the supporting pole 260a. The rod 230 relatively rotates along the supporting pole 260a and the rotation centre 254c axis is parallel to the rod 230. When one end of the rod 230 is not confined between the pivoting arm 254 and holding base 220, the rod 230 can be lifted and rotate for going through the spine portion 24 of the book 20. Hence the document binder 200 bonds with the book 20.

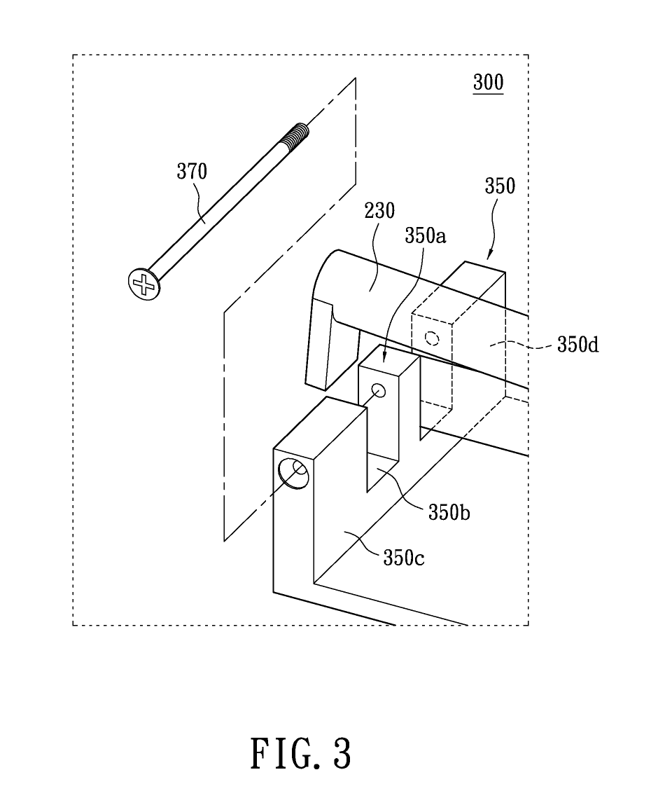

FIG. 3 is a perspective view of a document binder 300 in accordance with another embodiment of the instant disclosure. Please refer to FIG. 3. The instant embodiment is formed in a similar manner to that of the aforementioned embodiment, document binder 200. For example, the document also 300 includes a second holding member 260, two rods 230 and a cover 110. However, the document binders 200, 300 differ by the first holding member 250, 350. The difference is described hereafter.

The first holding member 350 of the document binder 300 has a trench 350a and a bolt 370. The trench 350a has a trench bottom 350b and a pair of opposite columns 350c, 350d projecting from the trench bottom 350b. In addition, in FIG. 3, another column is present between the columns 350c, 350d while in another embodiment the additional column is optional.

The bolt 370 goes through the columns 350c, 350d for retaining the rod 230 between the bottom 350b and bolt 370. Thus, the rod 230 is secured between the first and second holding members 350, 260.

It is worth noted that in the aforementioned embodiments, each of the document binders 200, 300 has two rods 230 but in another embodiment, the document binders 200, 300 may have one, three or more than three rods 230. Additionally, the document binder 100 can have two or more than two rods 230. It should be understood that the number of rods 230 may vary and not limited by the aforementioned exemplary embodiments.

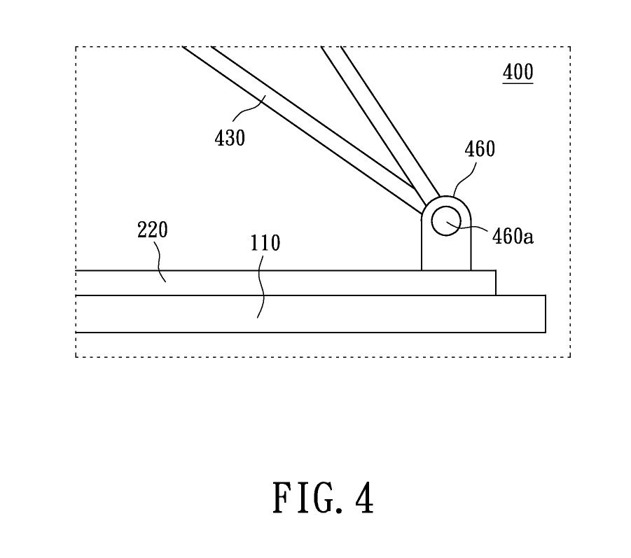

FIG. 4 is a perspective view of a document binder 400 in accordance with another embodiment of the instant disclosure. Please refer to FIG. 4. The instant embodiment is formed in a similar manner to that of the aforementioned embodiment, document binder 300. For example, the document 400 includes a cover 110, a holding base 220, a rod 430 and a second holding member 460. The rod 430 can also go through the spine portion 24, allowing the document binder 400 for bonding with the book 20. The difference between the second holding members 260, 460 is further described hereafter.

The second holding member 460 of the document binder 400 has a shaft 460a. The shaft 460a goes through the end of the rod 430 and second holding member 460 and connects there-between. Also, the shaft 460a is disposed atop the holding base 220. In addition, rod 430 can pivotally connect the second holding member 460 by the shaft 460a and the shaft 460a acts as a rotation axis. That is to say the shaft 460a enables the rods 430 rotating within the second holding member 460.

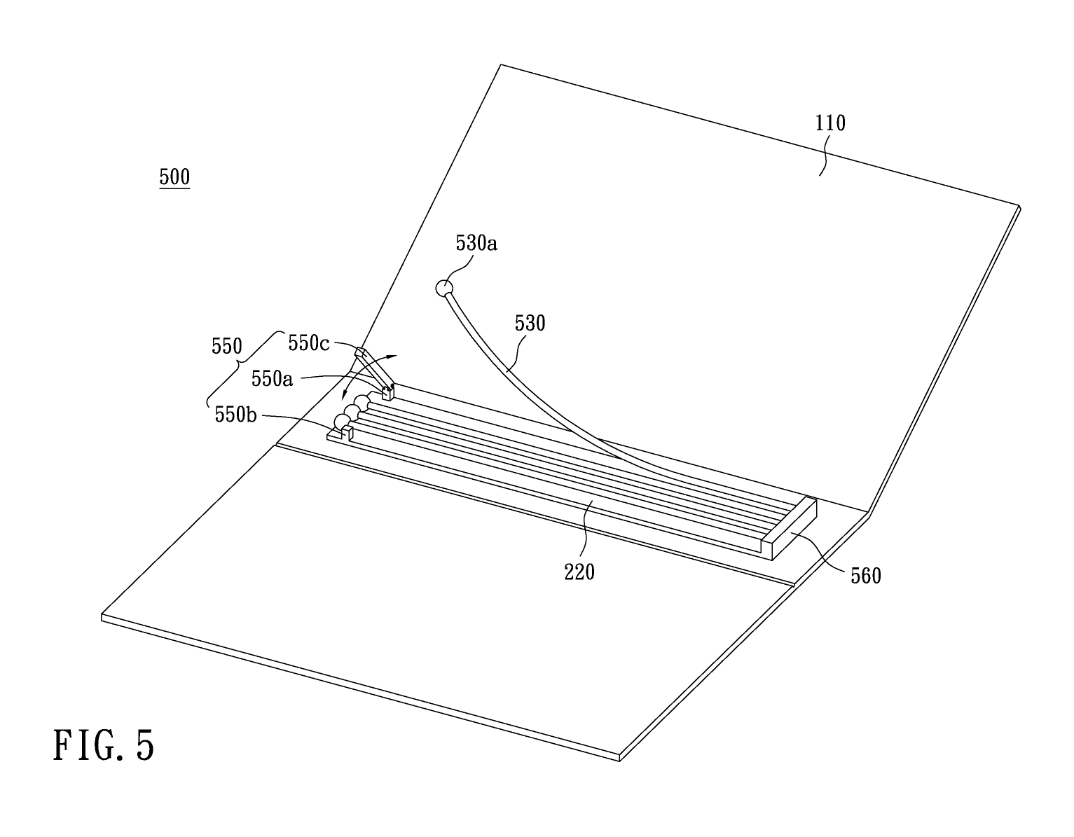

FIG. 5 shows a perspective view of a document binder 500 in accordance with another embodiment of the instant embodiment. Please refer to FIG. 5. The instant embodiment is formed in a similar manner to that of the aforementioned embodiment, document binder 400. For example, the document 500 includes a cover 110, a holding base 220, rods 530, a first holding member 550 and a second holding member 560. The difference between the document binder 500 and the aforementioned embodiment is further elaborated hereafter.

The first holding member 550 of the document binder 500 has a first column 550a, a second column 550b and a rotation arm 550c. The first column 550a is arranged opposite to the second column 550b. The rotation arm 550c is disposed atop the abreast columns 550a, 550b. One end of the rotation arm 550c pivotally connects to the first column 550a and therefore the rotation arm 550c can pivot by using the first column 550b as a fulcrum. The other end of the rotation arm 550c can be fixed on the second column 550b. Thus, one end of the rod 530 is confined between the rotation arm 550c and the holding base 220.

Furthermore, the document binder 500 includes a plurality of rods 530. The rods 530 may be resilient stick with certain flexibility. The rods 530 can have a top portion 530a shaped as a ball (as shown in FIG. 5). The top portion 530a is larger than the remaining portion of the rod 530. The top portion 530a measures larger than the void defining by the rotation arm 550c and the base 220 when the rotation arm engages with the second column 550b. Hence, the rods 530 can be secured on the first holding member 550. Additionally, the opposite end of the top portion 530a of the rod 530 is firmly secured with the second holding member 560 and disposed atop the holding base 220.

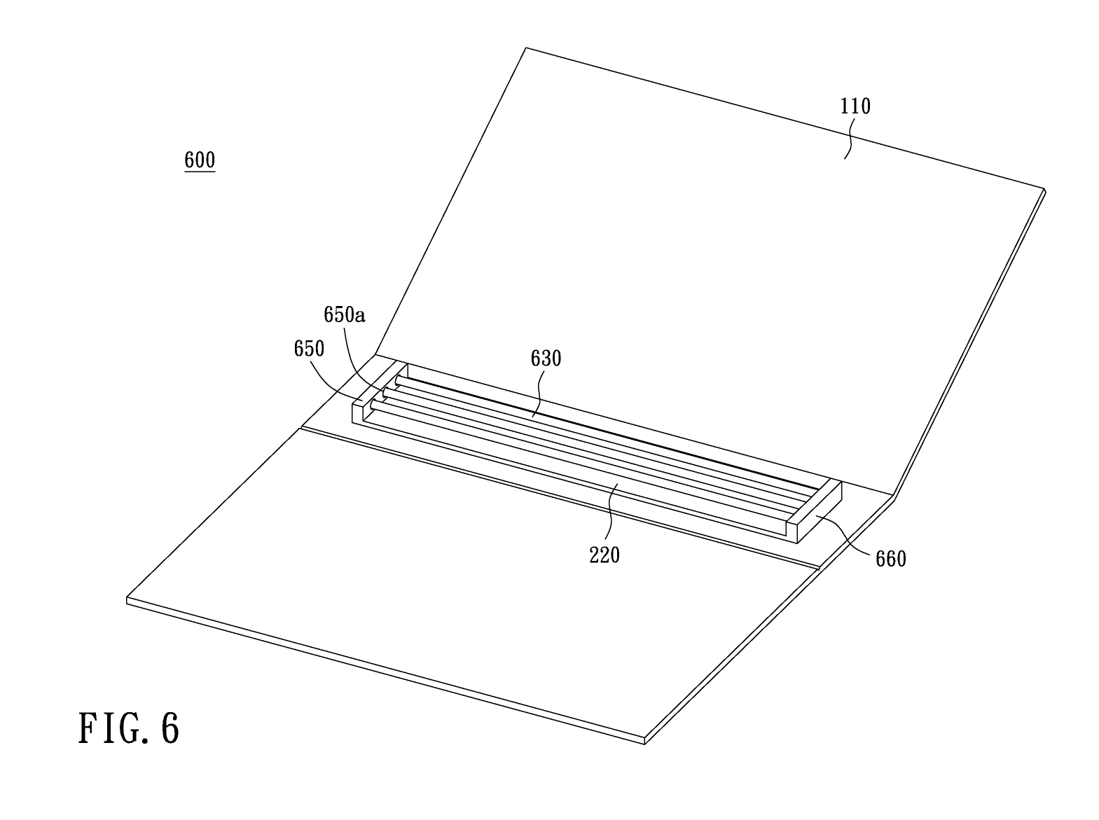

FIG. 6 is a perspective view of a document binder 600 in accordance with another embodiment of the instant disclosure. The instant embodiment is formed in a similar manner to that of the aforementioned embodiment, document binder 500. For example, the document 600 includes a cover 110, a holding base 220 and a second holding member 660. The difference between the document binders 500, 600 is elaborated hereafter.

The document binder 600 includes a plurality of rods 630. The rods 630 may be made of different materials used for document binder 500 in the aforementioned embodiment. For example, the rods 630 may be solid pole like metal. Additionally, one end of the rod 630 is firmly secured on the second holding member 660 and disposed atop the holding base 220. The tip of the rod 630 can be secured by screw threads mating to the second holding member 660.

Specifically, the second holding member 660 has a plurality of screw holes corresponding to those of the rods 630. Each tip of the rods 630 has male threads and each of the screw holes has female threads match thereto. Thus, the mating between the male and female threads allows each tip of the rods 630 for being secured on corresponding screw hole of the second holding member 660. In other words, the rods 630 are firmly engaged with the second holding member 660 by thread mating.

The first holding member 650 can have a plurality of holes 650a. The holes 650a receive rods 630 therein and the rods 630 are mobile therein. In addition, the first holding member 650 can be secured on top of the holding base 220, providing access for rods 630.

In conclusion, the instant disclosure provides the document binder by using at least one rod, which is secured between the first and second holding members, to go through the spine portion of a book. The document binder can bond with the book and provide protection against stain or damage.

The descriptions illustrated supra set forth simply the preferred embodiments of the instant disclosure; however, the characteristics of the instant disclosure are by no means restricted thereto. All changes, alternations, or modifications conveniently considered by those skilled in the art are deemed to be encompassed within the scope of the instant disclosure delineated by the following claims.

What is claimed is:

1. A document binder for bonding with at least one book, the book including a spine portion, comprising:
a cover including a front cover, a back cover and a back board disposed between the front cover and the back cover, wherein the back board includes a base plate pivotally connecting the front cover and the back cover and allowing the front and back covers pivoting there-toward;
a holding base secured on the back board while immobile thereon, the holding base including an upper face and a lower face opposing the upper face, the lower face disposed between the upper face and the back board;
a first holding member disposed on one end of the holding base and projecting there-from;
a second holding member disposed on the other end of the holding base and projecting there-from; and
at least one rod going through the spine portion, the two ends of the rods retained by the first holding member and second holding respectively.

2. The document binder according to claim 1, wherein the cover is made of soft material.

3. The document binder according to claim 1, wherein the base plate includes at least one pair of opposite linear edges, the linear edges connect the front cover and the back cover respectively, and at least one rod extends along while within the linear edges.

4. The document binder according to claim 1, wherein the number of rod is one or more, each of the rods is arranged in parallel between the first and second holding members, and the rods are uniformly apart from the upper face.

5. The document binder according to claim 1, wherein the rod resembles a stick exhibiting flexibility and resilience.

6. The document binder according to claim 1, wherein the first holding member includes at least one first rod hole for the rod insertion.

7. The document binder according to claim 6, wherein the second holding member includes at least one second rod hole for the rod insertion.

8. The document binder according to claim 7, wherein one end of the rod includes an arresting portion, the arresting portion abuts the second holding member after the rod insertion, and the second holding member is between the arresting portion and the first holding member.

9. The document binder according to claim 8 further comprising at least one cap engaging with the other end of the rod, the cap abutting the first holding member after the rod insertion, and the first and second holding members being sandwiched by the cap and arresting portion.

10. The document binder according to claim 1, wherein the first holding member comprising:
a seat including a bottom, a first column and a second column, the first column and second column projecting from the bottom and the bottom secured on the holding base, wherein the first column has a top end formed with a screw hole;
a pivoting arm having a through hole corresponding to the screw hole and pivotally connecting the second column, wherein the through hole and the screw hole align upon the pivoting arm closing toward the second column; and
a fastener received by the through hole and screw hole.

11. The document binder according to claim 10, wherein the pivoting arm rotates along a rotation centre toward the second column and the rotation centre axis is parallel to the rod.

12. The document binder according to claim 10, wherein the rod pivotally connects to the second holding member.

13. The document binder according to claim 12, wherein one end of the rod is a hook portion and the hook portion engages with the second holding member.

14. The document binder according to claim 13, wherein the second holding member comprising a supporting pole, a third column and a fourth column, the supporting pole engages with the hook portion, the hook portion is disposed between the third column and fourth column, the third column and fourth column project from the holding base, and the third column and fourth column are disposed between the supporting pole and holding base.

15. The document binder according to claim 10, wherein the rod is substantially L-shaped including a bent portion and an extension connecting the bent portion, and the bent portion stretches from the bent portion toward the base plate.

16. The document binder according to claim 1, wherein the first holding member comprising:
a trench including a trench bottom and a pair of opposing columns, the columns projecting from the trench bottom; and
a bolt received by the columns laterally for retaining the rod in between the columns and underneath the bolt.
